(19) United States
(12) Patent Application Publication
(10) Pub. No.: US 2002/0149161 A1
(43) Pub. Date: Oct. 17, 2002

(54) System and method for reducing risk of vehicle rollover

(76) Inventor: Donald Wayne Smith, Sacramento, CA (US)

Correspondence Address: THOMAS B. LUEBBERING, HOVEY, WILLIAMS, TIMMONS & COLLINS, 2405 Grand, Suite 400, Kansas City, MO, 64108, US

(21) Appl. No.: 09/832,402

(22) Filed: Apr. 11, 2001

(51) Int. Cl. B60G 17/01

(52) U.S. Cl. 280/5.507; 280/5.5

(57) ABSTRACT

A system and method for reducing vehicle rollover risk by automatically adjusting or tilting, in response to sensed driving conditions, the position of a vehicle body relative to a vehicle chassis (14) so as to shift the vehicle's COG and thereby compensate for or counteract dangerous centrifugal forces acting on the vehicle due, for example, to cornering or high-speed maneuvering. The system broadly comprises a computer (20); a plurality of sensors (22); front and rear controllers (24,25); and four or more height adjusters (26). The computer (20), in response to input from the sensors (22), commands the front and rear controllers (24,25) to cause the hydraulic or pneumatic height adjusters (26) to adjust the vehicle body's position so as to counteract rollover-inducing forces. The sensors (22) include steering (30), sway (32), speed (34), and angle-measuring (36) sensors.

### BACKGROUND OF THE INVENTION

1. Field of the Invention

The present invention concerns vehicle suspension systems and stability-maintaining safety systems. More particularly, the present invention relates to a suspension safety system having adjustable components operable to reduce vehicle rollover risk by adjusting or tilting, in response to sensed driving conditions, the position of a vehicle body relative a vehicle chassis so as to compensate for or counteract dangerous centrifugal forces acting on the vehicle.

2. Description of the Prior Art

A number of vehicles, particularly sport utility vehicles (SUVs), trucks, and vans, are unstable and at high risk of rolling over during cornering and high-speed maneuvering. This is due in great part to the physics of these vehicles, particularly their high center of gravity (COG). The COG is the point at which the vehicle's mass is at perfectly balanced equilibrium. The COG is also the point through which all forces affecting the vehicle act, whether due, for example, to braking, turning, or accelerating. Once moving, according to Newton's first law of motion, inertia will cause the COG to continue moving in a straight line until acted upon by another force. Rollovers typically occur when drivers attempt to turn or swerve. As the vehicle's tires turn against the direction of travel, a lateral force is created that is opposed by an equal and opposite centrifugal force propelling the vehicle toward the outside of the turn. The centrifugal force causes the vehicle's weight to shift onto the outside tires and potentially causes the inside tires to lift clear of the ground, thereby increasing rollover risk in the direction of the weight shift. Other factors, including load distribution, tire pressure, weather, and road conditions, also affect rollover risk.

A vehicle's tendency to roll is called its static stability factor (SSF) and is equal to the height of the COG divided by half the vehicle' track width, where track width is the distance between the vehicle's front tires. Vehicles with a higher SSF are less likely to roll over. SUVs are typically designed with a COG four to six inches higher than average passenger cars, but without a proportionally increased track width. Though SUV rollover risk could be reduced by designing a vehicle with a lower COG or an increased track width, such a design would change the very nature of the SUV away from the high-riding, roomy, relatively heavy vehicle consumers demand.

Rollover risks are of particular concern given that SUVs and other top-heavy vehicles currently account for 30% of all vehicles and may reach 50% within the next decade. Thus, due to the above-identified and other problems in the art, a system and method for reducing vehicle rollover risk is needed.

### SUMMARY OF THE INVENTION

The present invention solves the above-described and other problems in the art to provide a system and method for reducing vehicle rollover risk. More specifically, the system incorporates adjustable components into a vehicle's existing suspension system so as to reduce rollover risk by automatically adjusting or tilting, in response to sensed driving conditions, the position of a vehicle body relative to a vehicle chassis so as to advantageously shift the COG and thereby compensate for or counteract dangerous centrifugal forces acting on the vehicle due, for example, to cornering or high-speed maneuvering.

The preferred system broadly comprises a computer; a plurality of sensors; front and rear controllers; and four or more height adjusters. The computer, in response to input from the sensors, commands the front and rear controllers to cause the height adjusters to adjust the vehicle body's position so as to counteract rollover-inducing forces. The sensors, including steering, sway, and speed sensors, sense driving conditions associated with increased rollover risk, and provide such information to the computer. The front and rear controllers control actuation of the height adjusters. The height adjusters are preferably hydraulically or pneumatically operable to independently raise and lower the vehicle body.

These and other advantages of the present invention are further described in the section entitled DETAILED DESCRIPTION OF A PREFERRED EMBODIMENT, below.

### BRIEF DESCRIPTION OF THE DRAWINGS FIGURES

A preferred embodiment of the present invention is described in detail below with reference to the attached drawing figures, wherein:

FIG. 1 is a schematic representation of a preferred embodiment of a front portion of the present invention; and

FIG. 2 is a schematic representation of a preferred embodiment of a rear portion of the present invention.

### DETAILED DESCRIPTION OF A PREFERRED EMBODIMENT

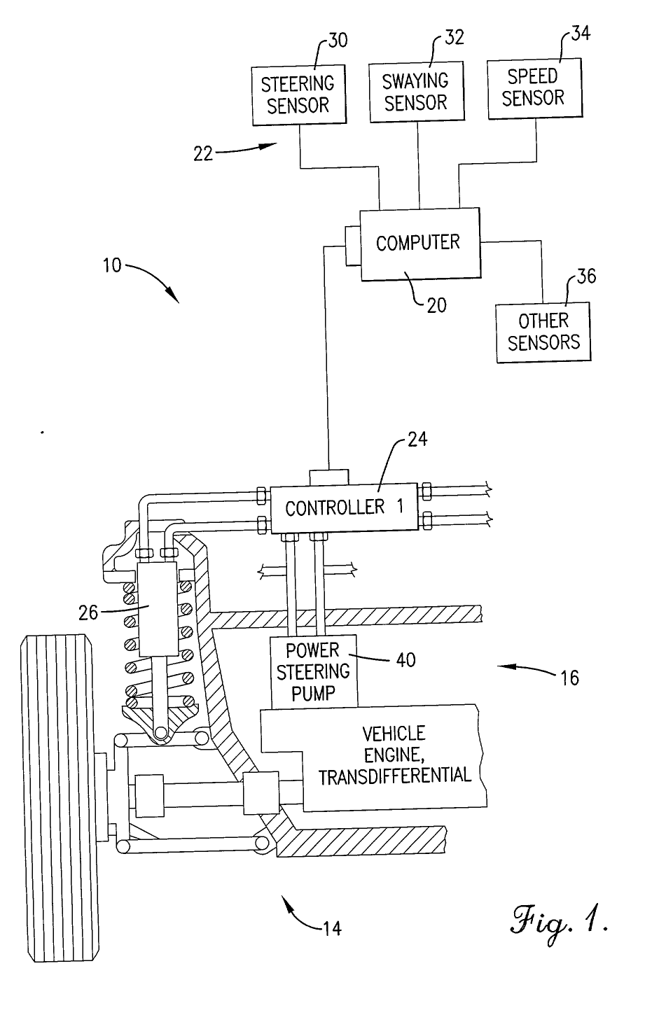

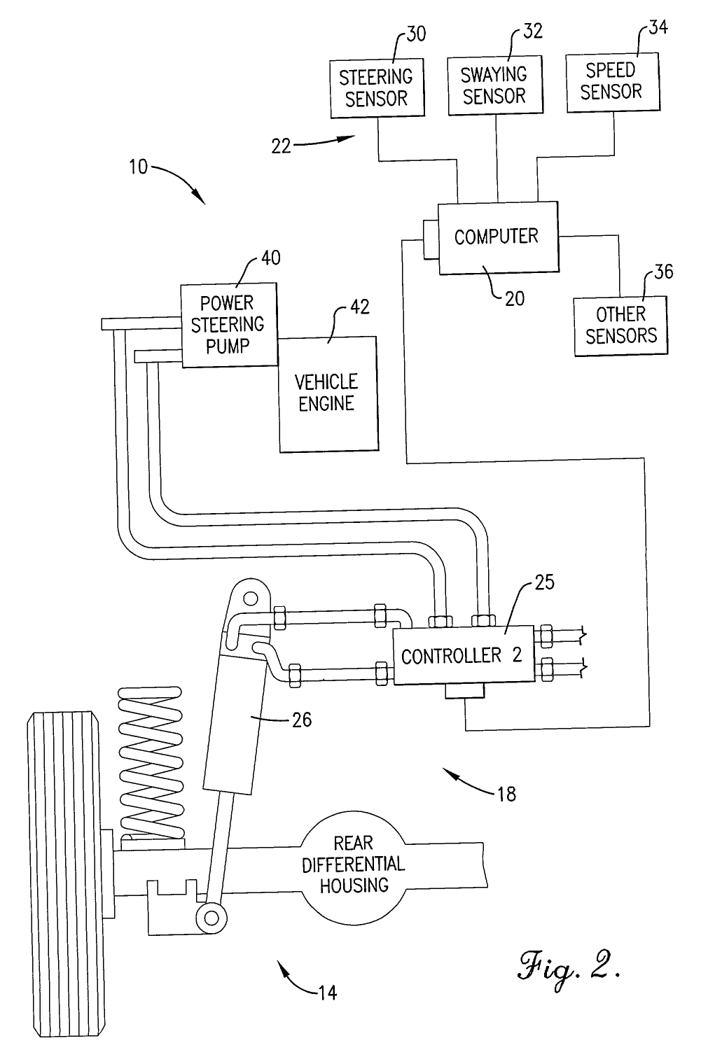

Referring to FIGS. 1 and 2, a system 10 is shown incorporated into a vehicle and operable to hydraulically or pneumatically adjust positioning, including angle and separation, between a vehicle body (not shown) and a vehicle chassis 14 in response to sensed rollover forces acting on the vehicle due, for example, to cornering or other maneuvering. The effect of such responsive adjustability is to advantageously reposition the vehicle's COG, thereby compensating for or counteracting centrifugal and other rollover forces and substantially reducing rollover risks. FIG. 1 shows a front portion of the system 10 incorporated into a front passenger-side suspension portion 16 of the vehicle; FIG. 2 shows a rear portion of the system 10 incorporated into a rear passenger-side suspension portion 18 of the vehicle. As will be appreciated by those with skill in the automotive engineering arts, identical front and rear portions of the system 10 are also incorporated, respectively, into front and rear driver-side suspension portions (not shown) of the vehicle.

Referring particularly to FIG. 1, a preferred embodiment of the system 10 broadly comprises a computer 20; a plurality of sensors 22; front and rear controllers 24,25; and four or more height adjusters 26. The computer 20 may be any automotive grade computing device operable to receive input from the sensors 22 and provide output based thereupon to responsively control angle and separation between the vehicle body and the vehicle chassis 14. As may be practical and desirable, the computer 20 may be an existing multi-purpose computing device controlling various vehicular functions, or a single purpose, specially adapted computing device dedicated for use with the present system 10.

The sensors 22 are operable to sense conditions relevant to the generation or presence of rollover forces and to generate signals corresponding thereto. The sensors 22 preferably include a steering sensor 30, a sway sensor 32, and a speed sensor 34. The steering sensor 30 is operable to measure vehicle steering angle; the sway sensor 32 is operable to measure amount of body sway; and the speed sensor 34 is operable to measure vehicle speed. Signals generated by the sensors 22 are provided to the computer 20 as input.

Other sensors 36 may be included as required or desired. In particular, an angle-measuring sensor 36 may be included operable to measure an angular orientation of the vehicle body relative to the vehicle chassis 14. The angle-measuring sensor's output is provided to the computer 20 as feedback regarding any actual effects of the computer-controlled hydraulic or pneumatic positioning adjustments. That is, without the angle-measuring sensor 36 or a similar feedback mechanism the computer 20 would have no way of directly ascertaining the effect, if any, of its control signals.

The front and rear controllers 24,25 are operable to control actuation of the height adjusters 26 in response to output by the computer 20. The nature of the controllers 24,25 is dependent upon the nature of the height adjusters 26 and other design considerations. In a preferred embodiment, for example, the controllers 24,25 are hydraulic/pneumatic valves or pumps. In the present invention, a raising or lowering of one side of the vehicle body is accompanied by a corresponding lowering or raising, respectively, of the opposite side.

The height adjusters 26 are preferably conventional hydraulically or pneumatically adjustable shock absorbers independently operable to raise or lower the vehicle's body relative to its chassis 14 in response to actuation by the front or rear controllers 24,25. In other embodiments, the height adjusters 26 may be hydraulic or pneumatic rams or pistons, mechanical levers or cams, or any other suitable and practical height-adjusting mechanism.

As will be appreciated by one with ordinary skill in the automotive engineering arts, the height adjusters 26 may be of either a push-push variety or a push-pull variety. In a push-push implementation, all movement of each height adjuster 26 is accomplished by an increase in pressure, with the direction of the applied pressure determining the nature of the response, either raising or lowering. In a push-pull implementation, raising is accomplished by increasing pressure (push), and lowering is accomplished by decreasing pressure (pull).

The height adjusters 26 each provide a first and a second end, with the first end being secured to the vehicle body and the second end being secured to the vehicle chassis 14. Furthermore, each vehicle wheel is preferably equipped with its own height adjuster 26 so as to provide four-wheel independent adjustability. In less preferred embodiments, the system includes only two height adjusters 26, one for the each side of the vehicle.

Where hydraulic, pneumatic, or other pressure-based height adjusters 26 are used, such pressure is preferably provided by an existing power steering pump 40 or similar device, which, in turn, is powered by the vehicle's engine 42. In other embodiments, hydraulic or fluid pressure may be provided by an auxiliary motor. In either case, the controllers 24,25 are operatively interposed between the pressure source and the height adjusters 26.

Where the height adjusters 26 are of the push-push variety, when the computer 20 signals the controllers 24,25 to actuate the height adjusters 26 to lower one side of the vehicle and raise the other, fluid is pumped into all height adjusters 26 to affect the desired total response. Where the height adjusters are of the push-pull variety, when the computer 20 signals the controllers 24,25 to actuate the height adjusters 26 to lower one side of the vehicle and raise the other, fluid or gas is removed from the height adjusters 26 on the side to be lowered and pumped into the height adjusters 26 on the side to be raised.

In operation, the above-described system 10 is incorporated, for example, into the suspension system of a vehicle. As the vehicle is maneuvered, the sensors 22 provide data to the computer 20. The computer 20 considers the sensor data and all other relevant factors, including the vehicle's weight, dimensions, and other physical characteristics, to determine whether a rollover risk exists and an appropriate response thereto. An appropriate response consists of actuating the height adjusters 26 by an amount operable to tilt the vehicle body relative to the vehicle chassis 14 so as to favorably relocate the COG and thereby reduce the rollover risk. Once an appropriate response, if any, is determined, the computer 20 provides corresponding signals to the controllers 24,25 so as to affect the response. The controllers 24,25, in turn, actuate the height adjusters 26 so as to appropriately lower one side of the vehicle body and raise the other. Where the height adjusters 24,26 are pressure-based, this is accomplished by removing media from the side to be lowered, and transferring it to the side to be raised. Feedback provided by the angle-measuring sensor 35 confirms that the proper angular orientation has been accomplished.

For example, given a vehicle weighing 3000 lbs and having a wheelbase of 104 inches and a tracking width of 64 inches, as the vehicle enters a first curve the steering sensor 30 measures an 8° steering angle (corresponding to a turning radius of 100 ft), and the speed sensor 34 measures vehicle speed to be 45 MPH. Based upon the vehicle's weight, dimensions, and physical characteristics, and the sensor-supplied performance data, the computer 20 determines that an appropriate response is to tilt the vehicle body 7° relative to the vehicle chassis 14 toward the inside of the turn. This corresponds to raising the outside height by 4.37 inches and lowering the inside height by 4.37 inches, which is accomplished by signaling the front and rear controllers 24,25 to actuate the height adjusters 26 accordingly. The result is a desirable compensatory shifting of the vehicle's COG so as to reduce rollover risk.

If the vehicle were entering the same turn at 22.5 MPH an appropriate response would be to tilt the vehicle body 3.5° relative to the vehicle chassis toward the inside of the turn. This corresponds to raising the outside height by 2.18 inches and lowering the inside height by 2.18 inches.

In another example, as the vehicle enters a second curve the steering sensor 30 measures a 5° steering angle (corresponding to a turning radius of 500 ft), and the speed sensor 34 measures vehicle speed to be 75 MPH. Based upon the vehicle's weight, dimensions, and physical characteristics, and the sensor-supplied performance data, the computer 20 determines that an appropriate response is to tilt the vehicle body 3.74° relative to the vehicle chassis 14 toward the inside of the turn. This corresponds to raising the outside height by 2.62 inches and lowering the inside height by 2.62 inches, which, again, is accomplished by signaling the front and rear controllers 24,25 to actuate the height adjusters 26. The result is a desirable compensatory shifting of the vehicle's COG so as to reduce rollover risk.

If the vehicle 10 were entering the same turn at 37.5 MPH the computer 20 would signal the front and rear controllers 24,25 to actuate the height adjusters 26 so as to tilt the vehicle body 1.87° relative to the vehicle chassis toward the inside of the turn. This corresponds to raising the outside height by 1.13 inches and lowering the inside height by 1.13 inches.

It is contemplated that the system 10 of the present invention may be incorporated into and share components with the vehicle safety system disclosed in a copending application titled “Vehicle Awareness Alerter”, Ser. No. 09/650,006, filed Aug. 28, 2000. Shared components may include, for example, the computer 20 and the sensors 22.

From the preceding description, it can be understood that the present invention offers distinct advances in the art of vehicle suspension systems and stability-maintaining safety devices. In particular, the present invention advantageously adjusts or tilts the vehicle body's position relative to the vehicle chassis in response to sensor data indicating a rollover risk, thereby shifting the COG and compensating for or counteracting centrifugal and other rollover forces.

Although the invention has been described with reference to the preferred embodiment illustrated in the attached drawings, it is noted that equivalents may be employed and substitutions made herein without departing from the scope of the invention as recited in the claims. Those skilled in the art will appreciate, for example, as noted above, that the responsive height adjustments called for by the present invention may be accomplished hydraulically, pneumatically, mechanically, or in any other suitable and practical manner.

Having thus described the preferred embodiment of the invention, what is claimed as new and desired to be protected by Letters Patent includes the following:

1. A system for reducing rollover risk in a vehicle having a vehicle body and a vehicle chassis, the system comprising:
a computer operable to receive input and to generate a first output in response thereto;
a plurality of sensors operable to provide input regarding a plurality of operating conditions of the vehicle;
a controller operable to receive the first output and to generate a second output in response thereto; and
a height adjuster coupled at a first portion with the vehicle body and at a second portion to the vehicle chassis, and operable in response to the second output to tilt the vehicle body relative to the vehicle chassis so as to counteract a rollover-inducing force.

2. The system as set forth in claim 1, wherein the plurality of sensors include:
a steering sensor operable to measure a steering angle condition of the vehicle;
a sway sensor operable to measure a sway condition of the vehicle; and
a speed sensor operable to measure a speed condition of the vehicle.

3. The system as set forth in claim 1, wherein the plurality of sensors includes an angle-measuring sensor operable to measure an angular orientation of the vehicle body relative to the vehicle chassis, and to provide such measurement to the computer.

4. The system as set forth in claim 1, wherein the height adjusters are hydraulic in nature.

5. The system as set forth in claim 4, wherein the vehicle includes an engine and the engine provides energy for generating hydraulic pressure for use by the height adjusters in tilting the vehicle body.

6. The system as set forth in claim 5, wherein the hydraulic pressure is provided by a power steering pump.

7. The system as set forth in claim 1, wherein the height adjusters are pneumatic in nature.

8. The system as set forth in claim 7, wherein the vehicle includes an engine and the engine provides energy for generating pneumatic pressure for use by the height adjusters in tilting the vehicle body.

9. The system as set forth in claim 1, wherein the height adjusters are selected from the group consisting of the following: hydraulically adjustable shock absorbers, pneumatically adjustable shock absorbers, hydraulic rams, pneumatic rams, hydraulic pistons, pneumatic pistons.

10. The system as set forth in claim 1, wherein the vehicle has four wheels and the system comprises four height adjusters, with each height adjuster being operatively associated with a respective wheel.

11. A system for reducing rollover risk in a vehicle having a vehicle body and a vehicle chassis, the system comprising:
a computer operable to receive input and to generate a first output in response thereto;
a steering sensor operable to measure a steering angle condition of the vehicle and to provide such measurement in the form of input to the computer;
a sway sensor operable to measure a sway condition of the vehicle and to provide such measurement in the form of input to the computer;
a speed sensor operable to measure a speed condition of the vehicle and to provide such measurement in the form of input to the computer;
an angle-measuring sensor operable to measure an angular orientation of the vehicle body relative to the vehicle chassis and to provide such measurement in the form of input to the computer;
a controller operable to receive the first output and to generate a second output in response thereto; and
an adjustable shock absorber coupled at a first portion with the vehicle body and at a second portion to the vehicle chassis, and operable in response to the second output to tilt the vehicle body relative to the vehicle chassis so as to counteract a rollover-inducing force.

12. The system as set forth in claim 11, wherein the vehicle includes an engine and the engine provides energy for generating a hydraulic pressure for use by the adjustable shock absorbers in tilting the vehicle body.

13. The system as set forth in claim 12, wherein the hydraulic pressure is provided by a power steering pump.

14. The system as set forth in claim 11, wherein the adjustable shock absorbers are pneumatic in nature.

15. The system as set forth in claim 14, wherein the vehicle includes an engine and the engine provides energy for generating pneumatic pressure for use by the adjustable shock absorbers in tilting the vehicle body.

16. The system as set forth in claim 11, wherein the vehicle has four wheels and the system comprises four adjustable shock absorbers, with each adjustable shock absorber being operatively associated with a respective wheel.

17. A method of reducing rollover risk in a vehicle by tilting a vehicle body relative to a vehicle chassis so as to counteract a rollover-inducing force, the method comprising the steps of:
(a) generating sensor data related to operating conditions of the vehicle, the operating conditions including, steering angle, sway, and speed;
(b) determining an appropriate response based upon the sensor data, where the appropriate response includes tilting the vehicle body relative to the vehicle chassis; and
(c) affecting the appropriate response by raising a first side of the vehicle body and lowering a second side of the vehicle body.

18. The method as set forth in claim 17, wherein step (c) is accomplished by increasing hydraulic pressure on the first side of the vehicle body and decreasing hydraulic pressure on the second side.

19. The method as set forth in claim 17, wherein step (c) is accomplished by transferring hydraulic pressure to the first side of the vehicle body from the second side.

20. The method as set forth in claim 16, wherein step (c) is accomplished by increasing pneumatic pressure on the first side of the vehicle body and decreasing pneumatic pressure on the second side.
